(19) United States
(12) Patent Application Publication
(10) Pub. No.: US 2007/0216115 A1
(43) Pub. Date: Sep. 20, 2007

(54) Hand truck incorporating an electric winch powered lifting base

(76) Inventor: Steven Lane Warner, Elk Grove, CA (US)

Correspondence Address: Steve Warner, 7117 Beaver Falls Way, Elk Grove, CA, 95758, US

(21) Appl. No.: 11/377,091

(22) Filed: Mar. 15, 2006

(51) Int. Cl. B62B 1/00; B62B 7/02; B60P 1/04

(52) U.S. Cl. 280/47.27; 414/490

(57) ABSTRACT

A lifting apparatus having a frame, a base unit and a winch unit. The frame includes wheels. The base unit is used to position an object on and is attached to the frame such that the base unit is moveable along the frame. The winch unit is attached to the frame and the base unit and provides a lifting force to the base unit in response to a control input.

### FIELD OF THE INVENTION

This invention relates generally to a hand/trolley truck and/or transport/lifting apparatus.

More particularly, after transporting an item with a hand truck, if the item needs to be lifted to another base above ground level, the item needs to be lifted manually.

Manual lifting of a heavy item may not always be possible by the person transporting the load, can cause undue physical strain often resulting in injury and/or loss of work or may require more than one person for lifting.

### BRIEF DESCRIPTION OF THE DRAWINGS

For a better understanding of the nature and objects of the invention, reference should be made to the following detailed description taken in conjunction with the accompanying drawings, in which:

FIG. 1 is an isometric view of the hand truck in accordance with an embodiment.

FIG. 2 is a left side view of the hand truck in accordance with an embodiment.

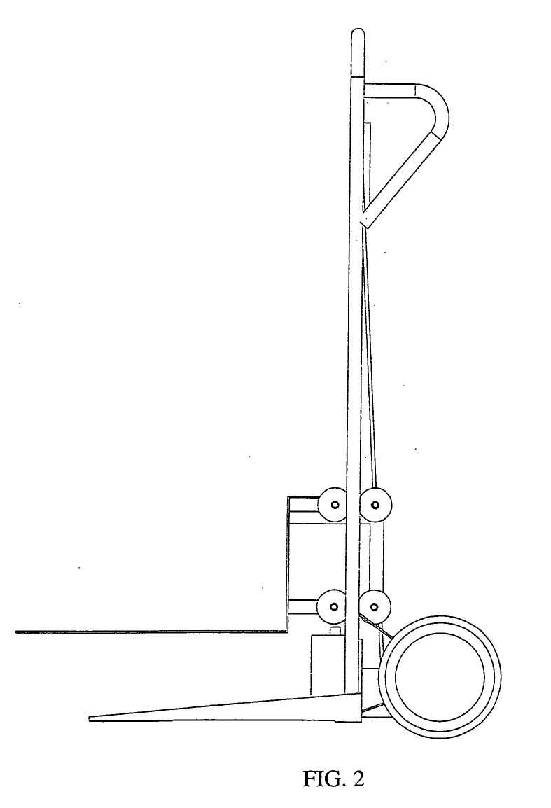

Note. With the exception of the control unit, the left side is a mirror image of the right side.

FIG. 3 is a top view of the lift base showing the section view cut -A-.

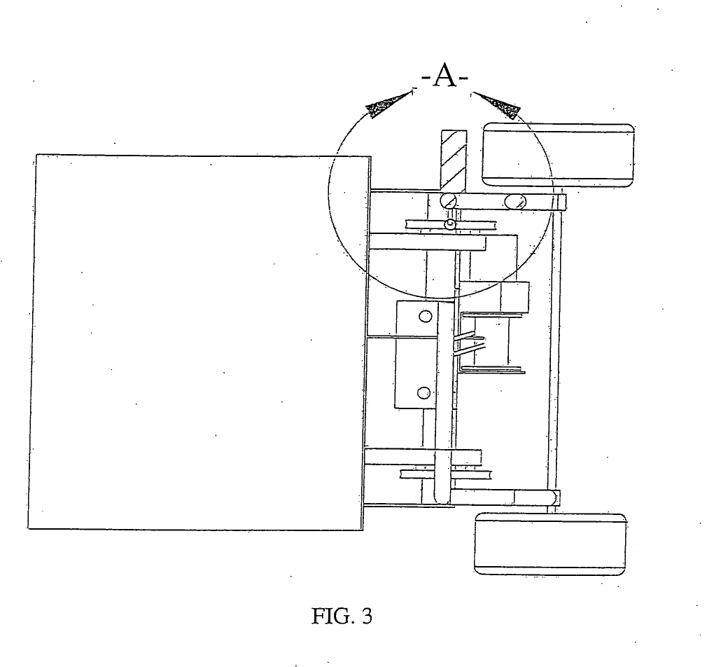

FIG. 4 is a section view, -A-, showing a V-groove wheel assembly in conjunction with square tubing guide rails.

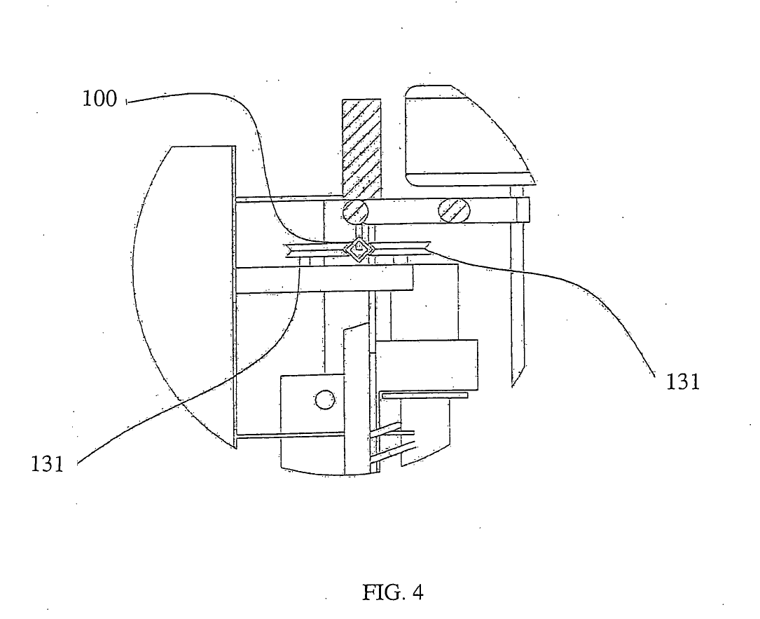

FIG. 5 is a section view, -A-, showing a V-groove wheel assembly in conjunction with flat bar guide rails.

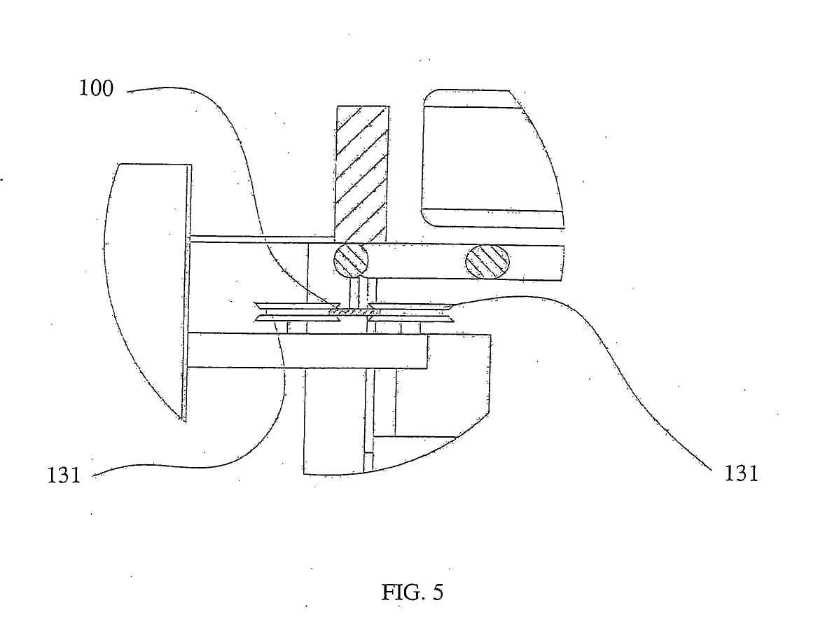

FIG. 6 is a section view, -A-, showing a U-groove wheel assembly in conjunction with round tubing guide rails.

Note: The right side wheel assembly is a mirror image of the left side wheel assembly.

### DESCRIPTION OF THE EMBODIMENTS

In an embodiment, a hand truck is equipped with an integrated electric winch. A steel cable from the electric winch is attached to a moveable lifting base. The lifting base is attached to guide rails on the hand truck via grooved wheel assemblies. An operator may control power delivery from a battery to the winch such that the lifting base can lift heavy loads selectively in an upward or downward direction. The hand truck, in an embodiment, is an apparatus that facilitates the movement of objects, typically large and/or heavy objects, from one location to another.

In an embodiment, the hand truck includes frame rails forming a rectangle laterally spaced and separated. Two U-shaped handles attach to either side of the upper frame rails facing towards the back of the hand truck. Two wheels for transporting the hand truck rotate on a common axle and are mounted at the rear base of the frame rails. Guide rails are attached parallel to and inwardly from the frame rails and are slightly shorter than the frame rails allowing a cross member rail to bridge between the upper ends of the guide rails extending between the frame rails. A pulley is attached to the under side of the cross member rail. Grooved wheel assemblies attach a lifting base to the guide rails. A support base, consisting of two rails extending perpendicular from the frame rails is attached at the base of the frame rails extending forward away from the transport wheels. An electric winch, mounted at the base of the frame of the hand truck and between the frame rails, includes a cable winding spool. A battery is mounted at the base of the frame of the hand truck and between the frame rails just in front of the winch. A control unit that is electrically and controllably connected to the winch and battery is mounted on one of the frame rails. The winch cable is attached to and extends upwards from the winch winding spool, through the pulley and back down to connect to the back of the lift base. The control unit selectively controls the inward and outward spooling of the winch cable about the winch spool. Spooling inward of the winch cable causes the cable to wind about the winch spool causing the lift base to move upward. Spooling the winch cable outward causes the cable to be released from the winch spool allowing the lift base to move downward due gravity acting upon the lift base.

An electromechanical switch is located both on the frame cross member and the frame base. The upper switch is aligned such that as the lift base nears contact with the frame cross member, the lift base contacts the switch before the lift base can come in contact with the frame cross member. The switch terminates power from the battery to the winch such that the winch no longer spools the cable in causing the lift base to stop its' upward movement. Stopping the lift base from contacting the frame cross member prohibits the winch from causing structural damage to the invention.

A similar switch is located at the base of the frame and aligned such that as the lift base is lowered and as the lift base reaches the bottom of it's travel, the lift base come in contact with the switch and terminates power from the battery to the winch such that the winch no longer spools the cable out. Allowing the winch cable to spool out after the lift base has reached the bottom of its' travel allows the cable to become entangled with itself about the winch spool. Cable entanglement can cause the lift base to suddenly drop as the cable becomes un-entangled in the course of being lifted or lowered.

### DETAILED DESCRIPTION OF THE EMBODIMENTS

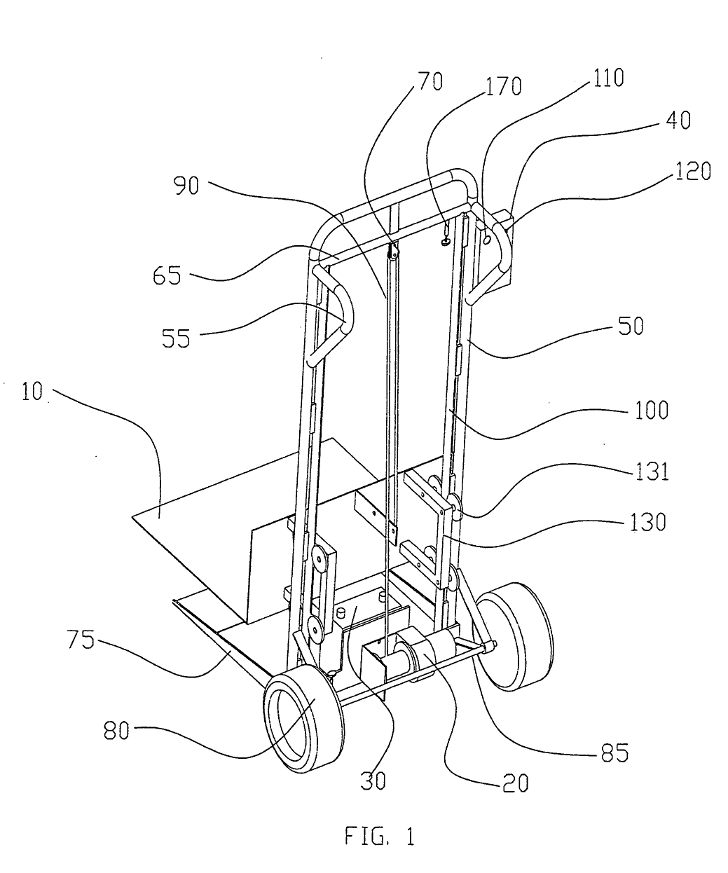

FIG. 1 is an isometric view of an embodiment of a hand truck with upright structural frame rails 50, U-shaped handles 55, guide rails 100, a cross member rail 65, wheels 80, axle 85, extended support base 75, lifting base 10, wheel assemblies 130, a winch 20, a battery 30, a control unit 40, a pulley 70 and a cable 90. As shown in FIG. 1, wheel assemblies 130 are used to attach the lifting base 10 to the guide rails 100.

In an embodiment, the guide rails 100 are square tubing rotated 45 degrees about their axis and mounted at the base of the frame rails 50 and at the bottom of cross member rail 65. The guide rails 100 are inward from and adjacent to the frame rails 50 with equal spacing along the length of the guide rails 100 and the frame rails 50.

The wheel assemblies 130 employ V-groove wheels 131. The “V” shape of the V-groove wheels 130 form a 90 degree angle allowing excellent fitment with the square tubing guide rails. The face of the V-groove wheels mate with the broad side of the square tube guide rails 100. There are two V-groove wheel assemblies 130 having both a left wheel assembly 130 and a right assembly 130. Each V-groove wheel assembly 130 includes four V-groove wheels 131 having both two upper wheels and two lower wheels and having both two front wheels and two rear wheels. It is the mating of the V-groove wheels and the square tubing guide rails 100 that provides the rotational resistance from the lift base when lifting un-balanced loads and demonstrates the uniqueness of the design.

Another embodiment further includes wheel assemblies including V-groove wheels 131. The guide rails 100 consist of flat bars and are similarly attached to the upright frame rails as were the square-tube guide rails 100. The V-groove wheels 131 are designed such that a notch at the base of the “V” shaped portion of the V-grooved wheels 131 mate with the narrow side of the flat bar guide rails 100. It is the mating of the V-groove wheels 131 and the flat bar guide rails 100 that provides the rotational resistance of the lift base when lifting un-balanced loads and demonstrates the uniqueness of the design.

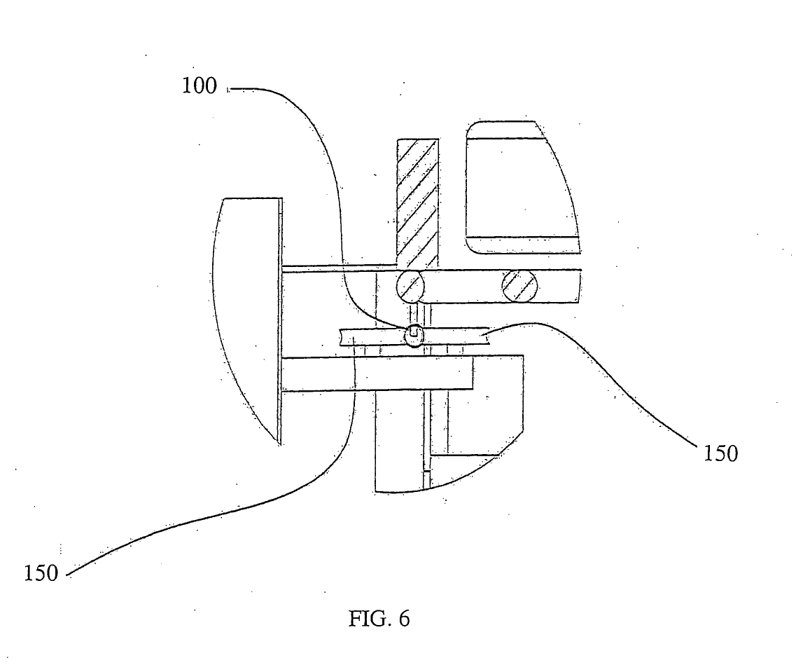

Another embodiment further includes wheel assemblies including U-groove wheels, 150 FIG. 6. The guide rails 100 consist of round tubing and are similarly attached to the upright frame rails as were the square-tube guide rails 100 and the flat bar guide rails 100. The U-groove wheels 150 are designed such that the U-grooved wheels 150 form a concave shape. The U-groove wheels 150 are mounted to the guide rails 100 such that the concave portion of the U-grooved wheels 150 mate with the round convex shape of the round tubing guide rails 100. It is the mating of the U-groove wheels 150 and the guide rails 100 that provides the rotational resistance of the lift base when lifting un-balanced loads and demonstrates the uniqueness of the design.

In an embodiment, the winch 20 is mounted at the base of the frame 50 and between the wheels 80. A battery 30 is mounted at the base of the frame 50 and between the wheels 80 just in front of the winch 20. Mounting the heavy components, the winch 20 and the battery 30, provides for a very low center of gravity which provides stability to the invention and make it easier to manipulate. A pulley 70 is attached to the lower portion at the frame cross member 55. A cable 90 attached to the winch spool 25 passes up through the pulley and then loops back down and attaches to the rear of the lifting base 10. Power from the battery 30 to the winch 20 is controlled by a control unit 40.

The control unit 40 incorporates both an up switch 110 FIG. 1, and a down switch 120 FIG. 1. When either the up switch 110 or the down switch 120 on the control unit 40 is manipulated, the application of electricity is transferred from the battery 30 to the winch 20. Manipulating the up switch 110 on the control unit 40 causes the winch 20 to spool the cable 90 inward about the spool 25 which causes the lifting base 10 to rise in a linear direction along the guide rails 100. Manipulating the down switch 120 on the control unit 40 causes the winch 20 to spool the cable 90 outward which causes the lifting base 10 to fall due to the force of gravity acting upon the lifting base 10. Cargo is selectively moved upward or downward in this manner.

An electromechanical switch 170 is mounted on the frame cross member 55. When the lift base 10 is lifted and has nearly reached the frame cross member 55, the lift base 10 contacts the switch 170 attached to the frame cross member 55 causing the electrical current in the wiring of the control unit 40 to cease application to the winch 20 causing the lift base 10 to cease it's upward movement.

Alternatively, an electromechanical switch 170 is mounted on the base of the frame 50. When the lift base 10 is being lowered from a lifted position and has reached the base of the frame 50, the lift base 10 contacts the switch 170 causing the electrical current in the wiring of the control unit 40 to cease application to the winch 20 causing the lift base 10 to cease it's downward movement.

While the foregoing description and drawings represent the preferred embodiments of the present invention, it will be understood that various additions, modifications and substitutions may be made therein without departing from the spirit and scope of the invention as defined in the accompanying claims. In particular, it will be clear to those skilled in the art that the present invention may be embodied in other specific forms, structures, arrangements, proportions, and with other elements, materials and components without departing from the spirit or essential characteristics thereof. The presently disclosed embodiments are therefore to be considered in all respects as illustrative and not restrictive, the scope of the invention being indicated by the appended claims and not limited to the foregoing description.

I claim:

1. A hand truck comprising:
a first guide rail and a second guide rail; a lifting base including attached grooved wheel assemblies which attach the lifting base to the first and second guide rails, the lifting base to be moved selectively in a linear direction along the guide rails;
an electric winch to provide a lifting force to the lifting base in response to a control input; and a control unit to provide the control input for manipulating electricity to the winch to raise or lower the lifting base.

2. The hand truck of claim 1 further including a battery coupled to the control unit.

3. The hand truck of claim 2 which further including a battery charger coupled to the battery.

4. The hand truck of claim 2 which further including a battery charger external to the hand truck.

5. The hand truck of claim 1 wherein the wheel assemblies include V-Groove wheels.

6. The hand truck of claim 1 wherein the wheel assemblies include U-Groove wheels.

7. The hand truck of claim 1 wherein the guide rails are square tubing.

8. The hand truck of claim 1 wherein the guide rails are round tubing.

9. The hand truck of claim 1 wherein the guide rails are flat bars.

10. The hand truck of claim 1, further including an energy source to provide power to the electric winch, wherein the energy source is electrically and controllably connected to the electric winch.

11. The hand truck of claim 8 wherein the energy source is a DC battery.
